(19) United States
(12) Patent Application Publication
(10) Pub. No.: US 2011/0042281 A1
(43) Pub. Date: Feb. 24, 2011

(54) GAS-DISSOLVED WATER SUPPLY SYSTEM

(75) Inventors: Hiroto Tokoshima, Tokyo (JP); Hiroshi Morita, Tokyo (JP); Shigeji Kametani, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: KURITA WATER INDUSTRIES LTD., Tokyo (JP)

(21) Appl. No.: 12/735,657

(22) PCT Filed: Mar. 13, 2009
(86) PCT No.: PCT/JP2009/054933

§ 371 Date: Sep. 30, 2010

(30) Foreign Application Priority Data
Mar. 14, 2008 (JP) 2008-066269

(51) Int. Cl. C02F 1/74; B01D 61/00; B01D 65/00

(52) U.S. Cl. 210/96.1; 261/72.1; 261/34.1; 261/20; 210/199

(57) ABSTRACT

Provided is a gas-dissolved water supply system that can efficiently produce highly concentrated gas-dissolved water and can circulate and supply the water to a use point. To a storage tank 1, waste water (cleaning waste water) that is water containing dissolved gas (oxygen) used for cleaning an object to be cleaned is reserved through piping 15, and feeding water is supplied through feeding water piping 1a. The water in the storage tank 1 is sent to a purification device 4 via a pressure feeding pump 2 and a heat exchanger 3 for keeping the water temperature constant. The water from which foreign substances are removed by the purification device 4 is sent to a degasser 6 via a flowmeter 5. Then, a gas is dissolved in the water by a gas-dissolving apparatus 7, a chemical is added to the water, and the water is supplied to a use point.

### FIELD OF INVENTION

The present invention relates to a gas-dissolved water supply system and, specifically, relates to a gas-dissolved water supply system suitable for, for example, a system supplying water for cleaning silicon wafers for semiconductors, glass substrates for flat panel displays, and so on.

### BACKGROUND OF INVENTION

In order to remove microparticles, organic substances, metals, and so on from surfaces of electronic materials such as semiconductor silicon substrates, liquid crystal glass substrates, and quartz substrate for photomasks, it has been performed wet cleaning using a hydrogen peroxide-based concentrated chemical solution at a high temperature, that is, a so-called RCA cleaning method. The RCA cleaning method is an effective method for removing metals, etc. on the surfaces of electronic materials, but it uses a large amount of an acid, an alkali, or hydrogen peroxide at a high concentration. Therefore, these chemical solutions are discharged into waste water and cause tremendous loads for neutralization, sedimentation treatment, and so on in waste disposal, and also a large amount of sludge is generated.

Accordingly, functional cleaning water prepared by dissolving a specific gas in ultrapure water and, according to need, adding a slight amount of a chemical thereto has been being used instead of the high concentrated chemical solutions. Examples of the specific gas used in the functional cleaning water include a hydrogen gas, an oxygen gas, an ozone gas, noble gases, and a carbon dioxide gas. In particular, when hydrogen gas-dissolved water containing a slight amount of ammonia, oxygen gas-dissolved water, noble gas-dissolved water such as argon gas-dissolved water, or carbon dioxide gas-dissolved water is used together with ultrasonication in a cleaning step, an extremely high microparticle-removing effect can be achieved.

The gas-dissolved water is produced by a gas-dissolved water producing apparatus and is stored once in a storage tank and then sent to a use point through piping. The surplus gas-dissolved water that has not been used at the use point is sent back by circular piping (for example, Patent Document 1).

[Patent Document 1] Japanese Unexamined Patent Application Publication No. 2000-271549

### SUMMARY OF THE INVENTION

It is an object of the present invention to provide a gas-dissolved water supply system that can efficiently produce highly concentrated gas-dissolved water and can circulate and supply the water to a use point.

The gas-dissolved water supply system according to a first aspect includes a gas-dissolving apparatus for dissolving a gas in raw water, supply means for supplying gas-dissolved water from the gas-dissolving apparatus to a use point, and waste water-sending back means for sending back for using as the raw water at least part of waste water used at the use point.

The gas-dissolved water supply system according to a second aspect is characterized in that, in the first aspect, the system further has unused gas-dissolved water-sending back means for sending back for using as the raw water at least part of unused gas-dissolved water at the use point.

The gas-dissolved water supply system according to a third aspect is characterized in that, in the first or second aspect, the system further has a water tank for storing raw water that is supplied to the gas-dissolving apparatus so that the water from the sending back means is introduced to the water tank.

The gas-dissolved water supply system according to a fourth aspect is characterized in that, in the third aspect, the system further has a pump for supplying water from the water tank to the gas-dissolving apparatus.

The gas-dissolved water supply system according to a fifth aspect is characterized in that, in the fourth aspect, wherein the water from the pump is purified by a purification device and then supplied to the gas-dissolving apparatus.

The gas-dissolved water supply system according to a sixth aspect is characterized in that, in any one of the first to fifth aspects, the system further has a degasser for degassing the water that is introduced to the gas-dissolving apparatus.

The gas-dissolved water supply system according to a seventh aspect is characterized in that, in the sixth aspect, wherein the degasser is a membrane degasser.

The gas-dissolved water supply system according to an eighth aspect is characterized in that, in any one of the first to seventh aspects, wherein the gas-dissolving apparatus is a gas dissolution membrane module in which a gas phase chamber and a water chamber is separated by membrane; and a gas is dissolved by supplying the gas to the gas dissolution membrane module in an amount larger than the amount of gas that can be dissolved in the water flowing at the time while discharging the surplus gas, which is the gas supplied but has not been dissolved, to the outside of the gas dissolution membrane module for discharging condensed water remaining in the gas phase chamber of the gas dissolution membrane module.

The gas-dissolved water supply system according to a ninth aspect is characterized in that, in any one of the first to eighth aspects, wherein the gas contains at least oxygen.

The gas-dissolved water supply system according to a tenth aspect is characterized in that, in any one of the first to eighth aspects, wherein the gas contains at least one selected from the group consisting of nitrogen, argon, ozone, carbon dioxide, hydrogen, clean air, and noble gases.

The gas-dissolved water supply system according to an eleventh aspect is characterized in that, in any one of the first to tenth aspects further including means for adding a chemical to at least one of the circulating water and the feeding water.

The gas-dissolved water supply system according to an twelfth aspect is characterized in that, in the eleventh aspect further has a measuring unit for measuring the chemical concentration or its equivalent in water and a chemical-injecting unit for maintaining a constant concentration of the chemical in the water to which the chemical is added.

When the gas-dissolved water not used at the use point is reused by circulating the water, highly concentrated gas-dissolved water can be efficiently produced and can be supplied to the use point by circulating and reusing at least part of the gas-dissolved water used at the use point. In addition, highly concentrated gas-dissolved water can be significantly efficiently supplied by circulating and reusing also the water unused at the use point.

Furthermore, though the water used at the use point contains foreign substances such as microparticles, clean gas-dissolved water can be supplied to the use point by purifying the water by a purification device and then supplying the purified water to the gas-dissolving apparatus.

The facilities can be simplified by using a pump for circulating water in the whole system also as the pump for introducing water to the purification device so that the water discharged from the pump for circulating water in the whole system is introduced to the purification device and then to the gas-dissolving apparatus.

### BRIEF DESCRIPTION OF DRAWINGS

FIG. 1 is a flow diagram of a gas-dissolved water supply system according to an embodiment.

FIG. 2 is a flow diagram of a gas-dissolved water supply system according to another embodiment.

### DETAILED DESCRIPTION

Embodiments will be described with reference to the drawings below.

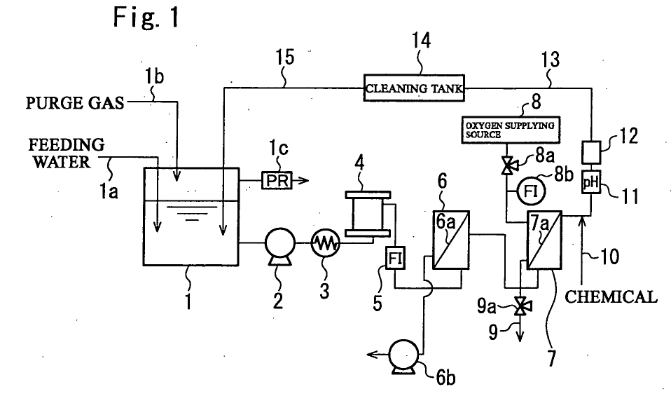

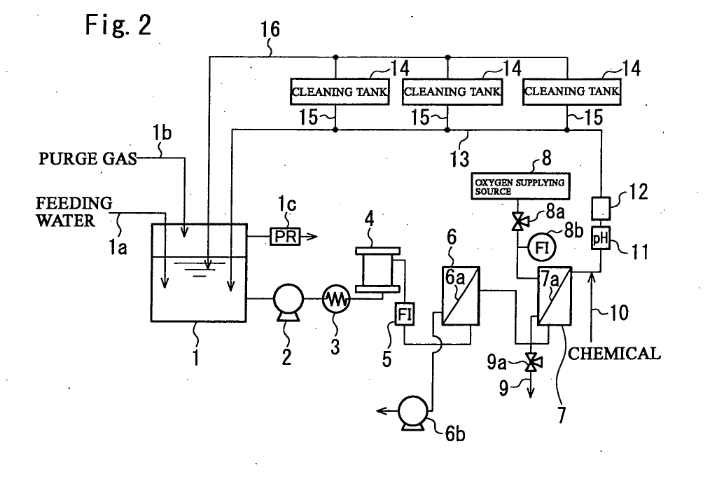

FIGS. 1 and 2 are each an explanatory drawing of one mode of a gas (oxygen in this embodiment)-dissolved water supply system according to an embodiment of the present invention. First, FIG. 1 will be described.

To a storage tank 1, waste water (cleaning waste water) that is water containing dissolved gas (oxygen) used for cleaning an object to be cleaned is resent through piping 15, and feeding water is supplied through feeding water piping la. The feeding water is desirably pure water or ultrapure water having a degree of cleanliness that can be supplied for cleaning or gas (oxygen)-dissolved water produced by another apparatus.

In order to maintain the degree of cleanliness of the storage tank 1, a purge gas may be supplied from purge gas piping 1b, and the inner pressure of the storage tank 1 may be adjusted to a pressure that is slightly, for example, about 10 to 50 mm Aq, preferably about 30 mm Aq, higher than the atmospheric pressure with a pressure regulating mechanism 1c so that the outside air does not enter. However, when a high degree of cleanliness is not required for an object to be cleaned, the purge gas is not necessarily required. Furthermore, when the gas (oxygen) to be dissolved is also used as the purge gas, after consideration of safety, dissipation of the gas from the water in the storage tank 1 can be prevented, and therefore it is preferred.

The storage tank 1 can also function as a cleaning tank 14 described below. In such a case, the feeding water piping 1a is connected to the cleaning tank.

The water in the storage tank 1 is sent to a purification device 4 via a pressure feeding pump 2 and a heat exchanger 3 for keeping the water temperature constant. In the purification device 4, foreign substances that are present in the water and substantially affect cleaning are removed together with part of water.

Incidentally, the heat exchanger 3 is mainly used for reducing the temperature by the degree elevated during circulation, but the water increased in temperature may be used for cleaning without installing the heat exchanger. Alternatively, the heat exchanger 3 may be used for heating. The heat exchanger 3 is desirably installed at the upstream side of the purification device 4.

The purification device 4 is, for example, UF membrane or MF membrane, and foreign substances are discharged together with brine water to the outside of the system.

The feeding water may be supplied at any position between from the storage tank 1 to the secondary side of the purification device 4. From the viewpoint of efficiently removing foreign substances by reducing the amount of water treated by the purification device 4, the secondary side of the purification device 4 is preferred. However, it accompanies complicated control in operation of the device. Therefore, the feeding water is preferably supplied to the storage tank 1 because of its easiness of controlling of the feeding water. For example, the amount of water substantially discharged to the outside of the system and the amount of feeding water can be well balanced by only keeping the water level in the storage tank 1 constant. Thus, the control is easy.

The water from which foreign substances are removed by the purification device 4 is sent to a degasser 6 via a flowmeter 5. The degasser 6 is preferably a membrane degasser having degassing membrane 6a. A gas phase chamber and a water chamber are separated by the degassing membrane 6a, and the gas dissolved in water is degassed by aspirating the gas phase chamber with a vacuum pump 6b. In order to smoothly discharge condensed water in the gas phase chamber, the gas phase chamber is desirably aspirated from the lower end of the chamber. The vacuum pump 6b is not limited, and, for example, a water seal or scroll vacuum pump is used. However, in a pump using oil for generating vacuum, the oil may be reversely diffused to contaminate the degassing membrane. Therefore, an oil-free pump is desirable.

The degassed water from the degasser 6 is sent to a gas-dissolving apparatus 7. The gas-dissolving apparatus 7 is preferably a gas dissolution membrane module in which a gas phase chamber and a water chamber is separated by membrane 7a. Oxygen gas is introduced to the gas phase chamber from an oxygen supplying source 8 via a regulation valve 8a and a flowmeter 8b. The oxygen gas passes through the membrane 7a and is dissolved in water in the water chamber. Surplus oxygen gas is discharged to the outside of the system from a gas exhaust line 9 having a gas exhaust valve 9a.

In order to discharge the condensed water remaining in the gas phase chamber of the gas dissolution membrane module, a gas is supplied to the dissolution membrane module in an amount larger than the amount of gas that can be dissolved in the water at the time, and the gas is allowed to be dissolved while discharging the surplus gas, which is the gas supplied but has not been dissolved, by opening the lower end of the membrane module to the air. In this case, it is preferable that the gas exhaust valve 9a be opened and that the gas dissolving operation be carried out while discharging part of the gas from the exhaust line 9. The amount of the gas supplied in this case is desirably about 1.1 to 1.5 when the amount of gas saturated in the water at the amount and temperature at the time is defined as 1, and preferably about 1.2 to 1.4 from the economic viewpoint and discharging properties. The adjustment of the dissolved gas concentration is desirably performed by changing the concentration of the supply gas.

Incidentally, the gas may be dissolved while keeping the gas exhaust valve 9a closed. In such a case, oxygen gas is supplied from the oxygen supplying source 8 in an amount corresponding to the water amount measured by the flowmeter 5 and the required concentration. The oxygen gas flow rate is measured by a gas flowmeter 8b, and the gas flow rate is controlled with the regulation valve 8a so that the flowmeter 8b indicates a desired level. A mass flow controller, which includes a flowmeter and a regulation valve in a unified manner, may be used. Furthermore, the oxygen gas amount may be controlled to a desired level by cooperating with the level indicated by a dissolved gas concentration meter 12.

As the oxygen supplying source 8, for example, PSA (pressure swing adsorption), liquefied oxygen, or oxygen obtained by water electrolysis is used, and PSA is suitable for continuous operation and is therefore preferred.

The gas-dissolved water from the gas-dissolving apparatus 7 is then confirmed with a pH meter 11 that the pH is within a predetermined range and is further confirmed with the dissolved gas concentration meter 12 that the dissolved oxygen concentration is at a predetermined level, and then the gas-dissolved water is supplied to the cleaning tank 14 via supply piping 13.

Furthermore, in order to enhance the cleaning effect, a chemical may be added to the gas-dissolved water with addition means 10. As the chemical, an alkali such as ammonia, NaOH, KOH, tetramethylammonium hydroxide, or choline, an acid such as HF, HCl, or H₂SO₄, a chelating agent, a surfactant, or combination thereof is used. The addition concentration of the chemical is measured with a concentration meter for the chemical, a pH meter, an ORP meter, an electric conductivity meter, or the like, and the supply amount is controlled to give a desired concentration. When pump injection is conducted, the injection amount can be controlled by adjusting the pulse frequency or the stroke length. When gas pressure Injection is conducted, the injection amount can be controlled by adjusting the gas pressure. The injection amount can be controlled also by adjusting the degree of opening of the valve in both methods above. The injection position is not limited to this, but is desirably just before or on a slightly upstream side of a concentration gauge (pH meter in FIG. 1) for well controlling the injection (by immediate response). The chemical may be added to the feeding water.

The cleaning waste water from the cleaning tank 14 is sent back to the storage tank 1 via sending back piping 15.

In FIG. 1, the whole gas-dissolved water from the gas-dissolving apparatus 7 is supplied to the cleaning tank 14 through the supply piping 13. In FIG. 2, the supply piping 13 is connected to the storage tank 1 at the end and has branched supply piping 15 on the way for supplying the gas-dissolved water to each cleaning tank 14 from the branched supply piping 15.

The cleaning waste water from each cleaning tank 14 is sent back to the storage tank 1 via piping 16. The surplus oxygen gas-dissolved water that has not been used for cleaning is also sent back to the storage tank 1, and this unused water is also reused as the raw water of gas-dissolved water.

Incidentally, the gas to be dissolved by the gas-dissolving apparatus may be at least one of nitrogen, argon, ozone, carbon dioxide, hydrogen, clean air, noble gases, and so on. Furthermore, mixture of at least one of them and oxygen may be dissolved.

### Examples

Examples and Comparative Examples will be described below.

### Example 1

The gas-dissolved water supply system shown in FIG. 1 was operated under the following conditions:

Purification device: OF membrane module, model KU-1510HUT, Kurita Water Industries Ltd.

Purge gas to storage tank: nitrogen

Storage tank pressure: +30 mm Aq

Water flow rate: 200 L/min

Feeding water flow rate: 20 L/min

Water supply pressure: 0.2 MPa

Target dissolved oxygen concentration: 36 mg/L (25° C.)

Injection chemical and concentration (pH): ammonia, pH 10

PSA was used as the oxygen supplying source. The purity of the oxygen gas was about 90%. Water from the purification device 4 was degassed with a degasser membrane module, and then oxygen gas was dissolved in the water with a dissolution membrane module. Incidentally, the gas exhaust valve 9a was opened for opening the lower end of the dissolution membrane module to the air. The oxygen supply rate was adjusted to 6.05 L (standard condition)/min, which is about 1.2 times the necessary rate.

Continuous operation while keeping the dissolved oxygen concentration at 36 mg/L was possible.

### Comparative Example 1

Operation was carried out as in Example 1 except that the cleaning waste water from the cleaning tank 14 was discarded without sending back to the storage tank 1.

The results showed that a feeding water flow rate of 200 L/min was necessary.

### Example 2

The gas-dissolved water supply system shown in FIG. 2 was operated under the same conditions as in Example 1 except that the water flow rate from the gas-dissolving apparatus 7 was 200 L/min, which is the same as that in Example 1, but 30 L/min thereof was sent back to the storage tank 1 without being used, and the remaining 170 L/min was supplied to the cleaning tank 14, by doing so, the whole cleaning waste water was sent back to the storage tank 1.

The results showed that the feeding water flow rate was 20 L/min, and the oxygen supply rate was 6.05 L/min.

### Comparative Example 2

Operation was carried out as in Example 2 except that the cleaning waste water from each cleaning tank 14 was discarded without sending back to the storage tank 1.

The results showed that a feeding water flow rate of 170 L/min was necessary.

As shown in Examples and Comparative Examples, in examples according to the present invention, it was possible to decrease the feeding water flow rate and efficiently supply the gas-dissolved water to a use point.

The present invention has been described in detail by using specific embodiments, but it is obvious to those skilled in the art that various modifications are possible without departing from the spirit and the scope of the present invention.

This application based on Japanese Patent Application (Patent Application No. 2008-066269) filed on Mar. 14, 2008, which is incorporated by reference herein in its entirety.

1. A gas-dissolved water supply system comprising a gas-dissolving apparatus for dissolving a gas in raw water, and supply means for supplying gas-dissolved water from the gas-dissolving apparatus to a use point,
wherein the system further comprises waste water-sending back means for sending back for using as the raw water at least part of waste water used at the use point.

2. The gas-dissolved water supply system according to claim 1, wherein the system further comprises unused gas-dissolved water-sending back means for sending back for using as the raw water at least part of unused gas-dissolved water at the use point.

3. The gas-dissolved water supply system according to claim 1, wherein the system further comprises a water tank for storing raw water that is supplied to the gas-dissolving apparatus so that the water from the sending back means is introduced to the water tank.

4. The gas-dissolved water supply system according to claim 3, wherein the system further comprises a pump for supplying water from the water tank to the gas-dissolving apparatus.

5. The gas-dissolved water supply system according to claim 4, wherein the water from the pump is purified by a purification device and then supplied to the gas-dissolving apparatus.

6. The gas-dissolved water supply system according to claim 1, wherein the system further comprises a degasser for degassing the water that is introduced to the gas-dissolving apparatus.

7. The gas-dissolved water supply system according to claim 6, wherein the degasser is a membrane degasser.

8. The gas-dissolved water supply system according to claim 1, wherein
the gas-dissolving apparatus is a gas dissolution membrane module in which a gas phase chamber and a water chamber is separated by membrane; and
a gas is dissolved by supplying the gas to the gas dissolution membrane module in an amount larger than the amount of gas that can be dissolved in the water flowing at the time while discharging the surplus gas, which is the gas supplied but has not been dissolved, to the outside of the gas dissolution membrane module for discharging condensed water remaining in the gas phase chamber of the gas dissolution membrane module.

9. The gas-dissolved water supply system according to claim 1, wherein the gas contains at least oxygen.

10. The gas-dissolved water supply system according to claim 1, wherein the gas contains at least one selected from the group consisting of nitrogen, argon, ozone, carbon dioxide, hydrogen, clean air, and noble gases.

11. The gas-dissolved water supply system according to claim 1, wherein the system further comprises means for adding a chemical to at least one of the circulating water and the feeding water.

12. The gas-dissolved water supply system according to claim 11, wherein the system further comprises a measuring unit for measuring the chemical concentration or its equivalent in water and a chemical-injecting unit for maintaining a constant concentration of the chemical in the water to which the chemical is added.
